(19) United States
(12) Patent Application Publication
(10) Pub. No.: US 2023/0128244 A1
(43) Pub. Date: Apr. 27, 2023

(54) AUTOMATED PROCESSES AND SYSTEMS FOR PERFORMING LOG MESSAGE CURATION

(71) Applicant: VMware, Inc., Palo Alto, CA (US)

(72) Inventors: Chandrashekhar Jha, Bangalore (IN); Siddartha Laxman LK, Bangalore (IN); Akash Srivstava, Bangalore (IN); Yash Bhatnagar, Bangalore (IN); Naveen Mudnal, Bangalore (IN)

(73) Assignee: VMware, Inc., Palo Alto, CA (US)

(21) Appl. No.: 17/511,341

(22) Filed: Oct. 26, 2021

(51) Int. Cl. G06F 16/332; G06F 16/17; G06F 16/33

(52) U.S. Cl. CPC G06F 16/3329; G06F 16/1734; G06F 16/3334

(57) ABSTRACT

Automated computer-implemented processes and systems described herein are directed to performing curation of log messages. The automated processes and systems filter unacceptable character strings from log messages to obtain curated text statements. The curated text statements contain human-readable text that enables a reader to understand the underlying messages contained in the log messages.

### TECHNICAL FIELD

Processes and systems that perform log curation on log messages generated in a distributed computing system.

### BACKGROUND

Data centers execute thousands of applications that enable businesses, governments, and other organizations to offer services over the Internet. These organizations cannot afford problems that result in downtime or slow performance of their applications. Problems frustrate users, damage a brand name, result in lost revenue, and deny people access to vital services. In order to aid system administrators and application owners with detection of problems, various management tools have been developed to collect performance information about applications, services, and hardware. A typical log management tool, for example, records log messages generated by various operating systems and applications executing in a data center. Each log message is an unstructured or semi-structured time-stamped message that records information about the state of an operating system, state of an application, state of a service, or state of computer hardware at a point in time. Most log messages record benign events, such as input/output operations, client requests, logins, logouts, and statistical information about the execution of applications, operating systems, computer systems, and other devices of a data center. For example, a web server executing on a computer system generates a stream of log messages, each of which describes a date and time of a client request, web address requested by the client, and IP address of the client. Other log messages record diagnostic information, such as alarms, warnings, errors, or emergencies.

Software engineers, developers, and troubleshooting teams use log messages to troubleshoot root causes of problems and monitor execution of an applications and systems that support execution of the application. However, problems with large distributed applications do not arise suddenly. Observable problems with large distributed applications often result from hidden problems that occur in the background or when no one is paying attention. Detection of a problem is further complicated because most large distributed applications running in a data center can generate millions of log messages per day with only a small fraction that can be used to troubleshoot the root cause of a problem with an application. As a result, unnoticed problems are often recorded in log messages that are buried deep in log files that contain millions of log messages, making manual detection of such log message challenging, error prone. and extremely time consuming and expensive. For example, consider a batch job that stores results in a data file in response to a user request. A batch job is a non-interactive program that runs off hours or runs in the background while interactive programs run in the foreground. Suppose that when the batch job runs, there is a Null Pointer Exception error in the program that was not noticed during debugging of the program. A Null Pointer Exception error occurs when a variable is declared in a program, but a value is not assigned to the variable before the variable is used to store a data value, resulting in data that should have been assigned to the variable not being written to a data file. When the error occurs during execution of the program, a log message describing the error is recorded in a log file along with millions of other log messages generated that day. However, because the batch job runs unnoticed by users, the problem with no data being written to the data file goes unnoticed until a user carefully inspects the data file.

Debugging an application, such as a batch job, at runtime is an ongoing challenge for developers, architects, and administrators of the application. Even with log management tools, discovering the root cause of an application problem is often performed by different teams of software engineers, including a field team, an escalation team, and a research and development team. Within each team, the search for a root cause is gradually narrowed by filtering millions of log messages through different sub-teams that examine and search for log messages that reveal specific problems. The troubleshooting process can take weeks and, in some cases, months. These long periods spent troubleshooting a problem often leads to increased cost for the organization and can lead to mistakes in processing transactions and denying people access to services provided by an organization. Developers, administrators, and application owners seek automated methods and systems that reduce the time to discovery of root causes of problems in applications using log messages.

### SUMMARY

Automated computer-implemented processes and systems described herein are directed to performing curation of log messages produced by log message sources of an application running in a distributed computing system. In one implementation, an automated process retrieves log messages that represent one or more classes of log messages with time stamps in a user-selected time interval from a log file stored in a log message database in response to receiving the time interval from a user via a graphical user interface (“GUI”). The process uses a Grok engine to construct a Grok expression for each of the log messages. The process filters unacceptable character strings from the log messages to obtain curated text statements based on the Grok expressions and acceptable character strings. The process displays the curated text statements. The curated text statements contain human-readable text that enables a reader to understand the underlying messages contained in the log messages.

### DESCRIPTION OF THE DRAWINGS

FIG. 1 shows an example of logging log messages in log files.

FIG. 2 shows an example source code of an event source.

FIG. 3 shows an example of a log write instruction.

FIG. 4 shows an example of a log message generated by the log write instruction in FIG. 3.

FIG. 5 shows a small, eight-entry portion of a log file.

FIGS. 6A-6C show an example of the log management server receiving log messages from event sources.

FIG. 7 shows an automated computer-implemented processes performed by a log management server for curating log messages and discovery of problems with an application.

FIG. 8A shows an example graphical user interface (“GUI”) that enables a user to select a time interval and displays classes of log messages.

FIG. 8B shows an example of log messages with time stamps in a user-selected time interval.

FIG. 9 shows a table of examples of primary Grok patterns and corresponding regular expressions.

FIG. 10 shows a table of examples of composite Grok patterns.

FIGS. 11A-11B show an example of parsing a log message with a Grok expression.

FIG. 12 shows an example list of disallowed Grok patterns.

FIG. 13 shows an example of tokens formed from character strings of a log message and corresponding Grok patterns of a Grok expression for the log message.

FIG. 14 shows an example of denying special characters and character strings that are outside permissible maximum and minimum character string lengths.

FIG. 15 shows an example list of allowed character strings stored in an allowed character string database.

FIG. 16 is a flow diagram of a process performed by a log management server for forming a set of curated text.

FIGS. 17A-17C show an example of forming a set of curated text using the process of FIG. 16.

FIG. 18 shows an example of discarding duplicate character strings and merging character strings to obtain a curated text statement.

FIG. 19 shows examples of curated text statements and associated tags.

FIG. 20 shows an example GUI that displays curated text statements.

FIG. 21 is a flow diagram of a method for performing curation of log messages.

FIG. 22 is a flow diagram illustrating an example implementation of the “filter unacceptable character strings from the log messages to obtain curated text statements based on the Grok expressions and acceptable character strings” procedure performed in FIG. 21.

FIG. 23 is a flow diagram illustrating an example implementation of the “filter disallowed character strings from the log message based on Grok patterns of the Grok expression” procedure performed in FIG. 22.

FIG. 24 is a flow diagram illustrating an example implementation of the “filter special characters and character strings based on string length” procedure performed in FIG. 22.

FIG. 25 is a flow diagram illustrating an example implementation of the “form a set of curated text from acceptable character strings” procedure performed in FIG. 22.

FIG. 26 shows an example of a computer system that executes operations performed by a log management server.

### DETAILED DESCRIPTION

This disclosure presents automated computer-implemented processes and systems that perform curation of log messages produced by log message sources of an application running in a distributed computing system. Log messages and log files are described below in a first subsection. An example of a log management server executed in a distributed computing system is described below in a second subsection. Processes and systems for performing curation of log messages are described below in a third subsection.

### Log Messages and Log Files

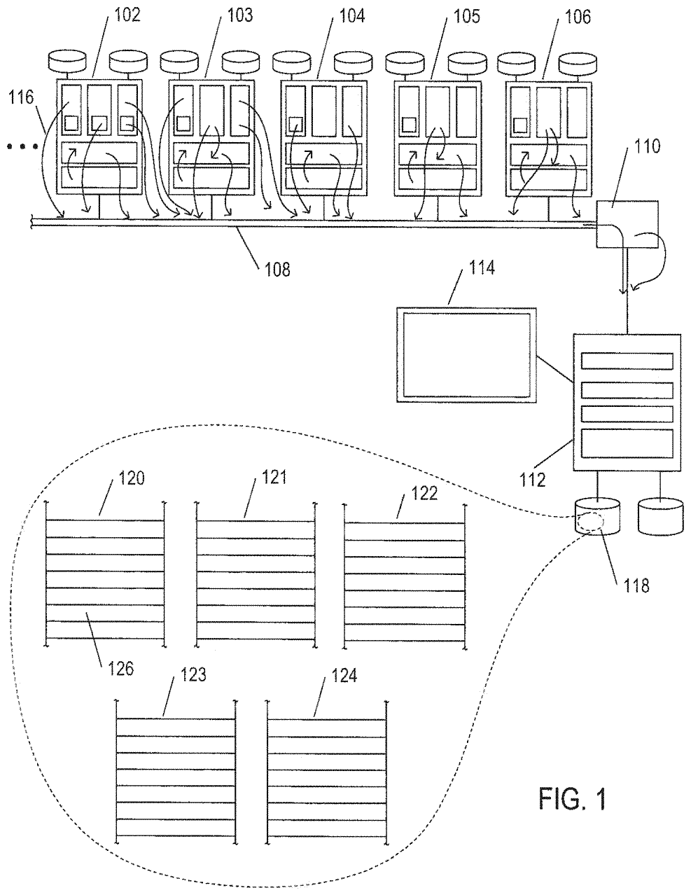

FIG. 1 shows an example of recording log messages in log files. In FIG. 1, computer systems 102-106 within a distributed computing system, such as data center, are linked together by an electronic communications medium 108 and additionally linked through a communications bridge/router 110 to an administration computer system 112 that includes an administrative console 114 and executes a log management server described below. Each of the computer systems 102-106 may run a log monitoring agent that forwards log messages to the log management server executing on the administration computer system 112. As indicated by curved arrows, such as curved arrow 116, multiple components within each of the discrete computer systems 102-106 as well as the communications bridge/router 110 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 102-106, the bridge/router 110 and any other components of a data center. Log messages may be received by log monitoring agents at various hierarchical levels within a discrete computer system and then forwarded to the log management server executing in the administration computer system 112. The log management server records the log messages in a data-storage device or appliance 118 as log files 120-124. Rectangles, such as rectangle 126, represent individual log messages. For example, log file 120 may contain a list of log messages generated within the computer system 102. Each log monitoring agent has a configuration that includes a log path and a log parser. The log path specifies a unique file system path in terms of a directory tree hierarchy that identifies the storage location of a log file on the administration computer system 112 or the data-storage device 118. The log monitoring agent receives a specific file and event channel log paths to monitor log files and the log parser includes log parsing rules to extract and format lines of the log message into log message fields described below. Each log monitoring agent sends a constructed structured log message to the log management server. The administration computer system 112 and computer systems 102-106 may function without log monitoring agents and a log management server, but with less precision and certainty.

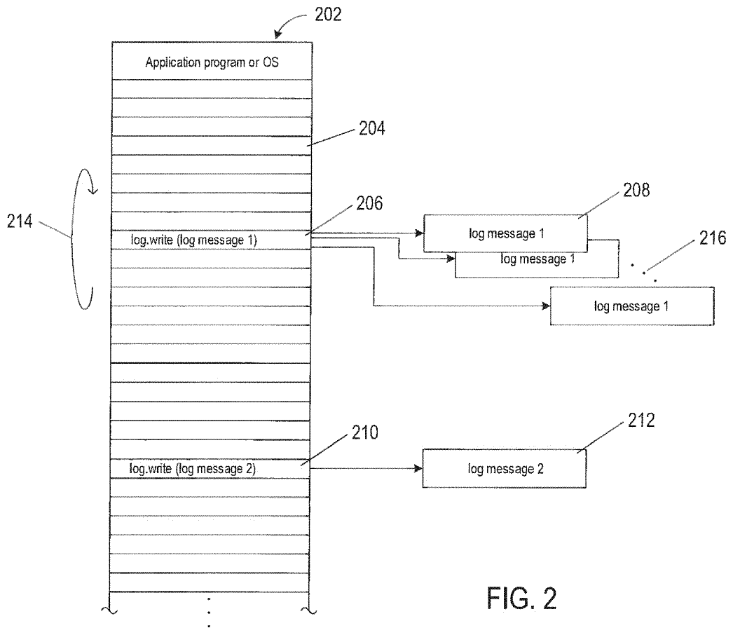

FIG. 2 shows an example source code 202 of an event source, such as an application, an operating system, a VM, a guest operating system, or any other computer program or machine code that generates log messages. The source code 202 is just one example of an event source that generates log messages. Rectangles, such as rectangle 204, represent a definition, a comment, a statement, or a computer instruction that expresses some action to be executed by a computer. The source code 202 includes log write instructions that generate log messages when certain events predetermined by a developer occur during execution of the source code 202. For example, source code 202 includes an example log write instruction 206 that when executed generates a “log message 1” represented by rectangle 208, and a second example log write instruction 210 that when executed generates “log message 2” represented by rectangle 212. In the example of FIG. 2, the log write instruction 208 is embedded within a set of computer instructions that are repeatedly executed in a loop 214. As shown in FIG. 2, the same log message 1 is repeatedly generated 216. The same type of log write instructions may also be located in different places throughout the source code, which in turns creates repeats of essentially the same type of log message in the log file.

In FIG. 2, the notation “log.write( )” is a general representation of a log write instruction. In practice, the form of the log write instruction varies for different programming languages. In general, the log write instructions are determined by the developer and are unstructured, or semi-structured, and in many cases are relatively cryptic. For example, log write instructions may include instructions for time stamping the log message and contain a message comprising natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices, fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

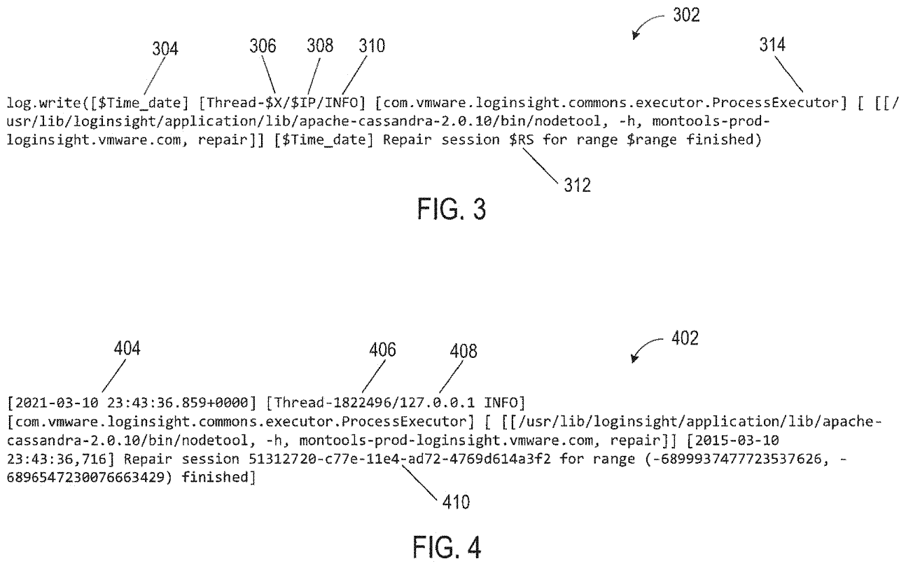

FIG. 3 shows an example of a log write instruction 302. The log write instruction 302 includes arguments identified with “$” that are filled at the time the log message is created. or example, the log write instruction 302 includes a time-stamp argument 304, a thread number argument 306, and an internet protocol (“IP”) address argument 308. The example log write instruction 302 also includes text strings and natural-language words and phrases that identify the level of importance of the log message 310 and type of event that triggered the log write instruction, such as “Repair session” argument 312. The text strings between brackets “[ ]” represent file-system paths, such as path 314. When the log write instruction 302 is executed by a log management agent, parameters are assigned to the arguments and the text strings and natural-language words and phrases are stored as a log message of a log file.

FIG. 4 shows an example of a log message 402 generated by the log write instruction 302. The arguments of the log write instruction 302 are assigned numerical parameters that are recorded in the log message 402 at the time the log message is executed by the log management agent. For example, the time stamp 304, thread 306, and IP address 308 arguments of the log write instruction 302 are assigned corresponding numerical parameters 404, 406, and 408 in the log message 402. Alphanumeric expression 410 is assigned to a repair session argument 312. The time stamp 404 represents the date and time the log message 402 is generated. The text strings and natural-language words and phrases of the log write instruction 302 also appear unchanged in the log message 402 and are used to describe the type of event (e.g., informative, warning, error, or fatal) that occurred during execution of the event source.

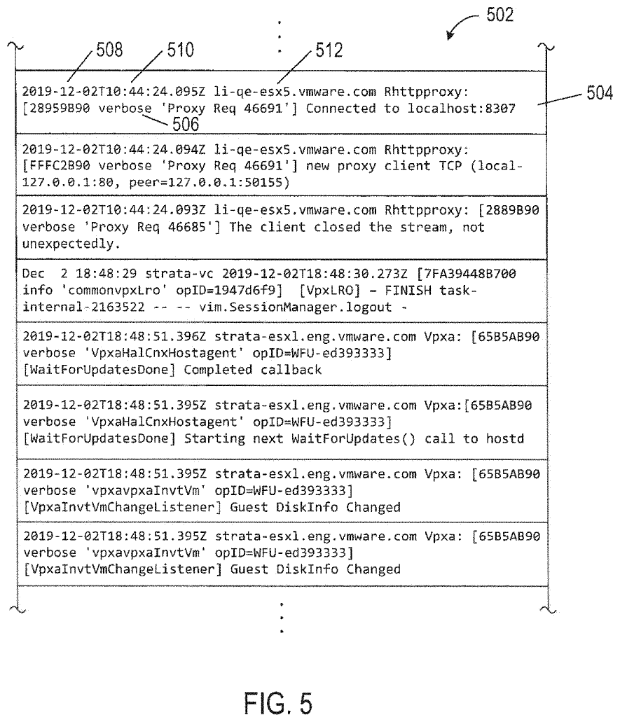

As the log management server receives log messages from various event sources, the log messages are stored in corresponding log files in the order in which the log messages are received. FIG. 5 shows a small, eight-entry portion of a log file 502. In FIG. 5, each rectangular cell, such as rectangular cell 504, of the log file 502 represents a single stored log message. For example, log message 504 includes a short natural-language phrase 506. date 508 and time 510 numerical parameters, and an alphanumeric parameter 512 that identifies a particular host computer.

### Log Management Server

In large, distributed computing systems, such as a data center, terabytes of log messages may be generated each day. The log messages may be sent to a log management server that records the log messages in separate log files that correspond to event sources are in turn stored in data-storage appliances.

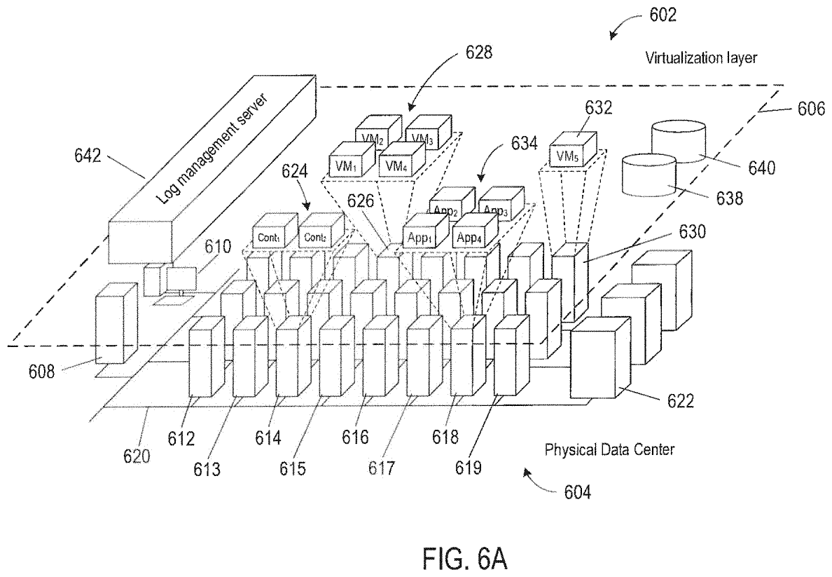

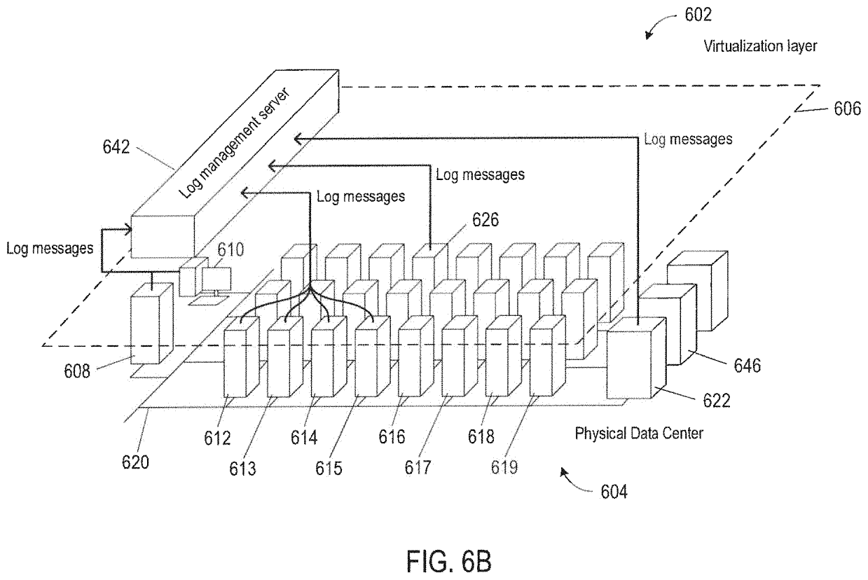

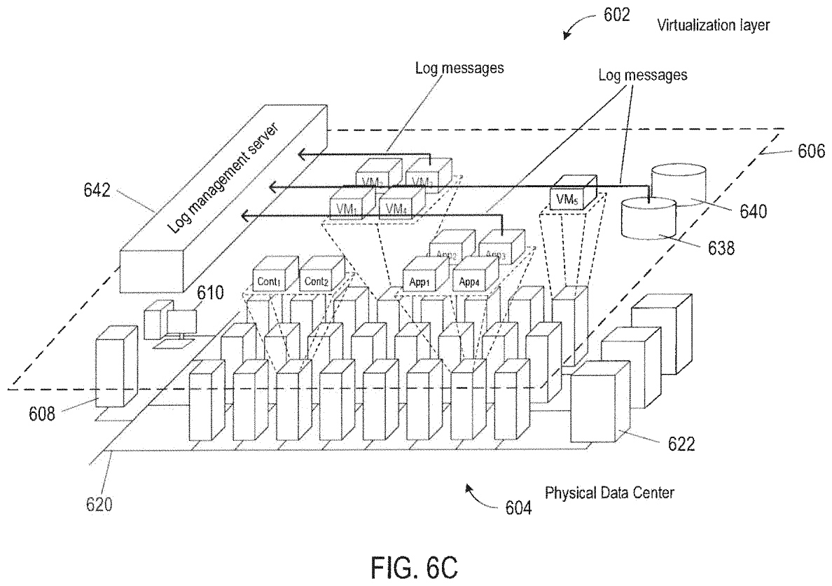

FIG. 6A shows an example of a virtualization layer 602 located above a physical data center 604. For the sake of illustration, the virtualization layer 602 is shown separated from the physical data center 604 by a virtual-interface plane 606. The physical data center 604 is an example of a distributed computing system. The physical data center 604 comprises physical objects. including an administration computer system 608, any of various computers, such as PC 610, on which a virtual-data-center (“VDC”) management interface may be displayed to system administrators and other users, server computers. such as server computers 612-619, data-storage devices, and network devices. The server computers may be networked together to form networks within the data center 604. The example physical data center 604 includes three networks that each directly interconnects a bank of eight server computers and a mass-storage array. For example, network 620 interconnects server computers 612-619 and a mass-storage array 622. Different physical data centers may include many different types of computers, networks, data-storage systems and devices connected according to many different types of connection topologies. The virtualization layer 602 includes virtual objects, such as VMs, applications, and containers, hosted by the server computers in the physical data center 604. The virtualization layer 602 may also include a virtual network (not illustrated) of virtual switches, routers, load balancers, and network interface cards formed from the physical switches, routers, and network interface cards of the physical data center 604. Certain server computers host VMs and containers as described above. For example, server computer 614 hosts two containers 624, server computer 626 hosts four VMs 628, and server computer 630 hosts a VM 632. Other server computers may host applications as described above with reference to FIG. 4. For example, server computer 618 hosts four applications 634. The virtual-interface plane 606 abstracts the resources of the physical data center 604 to one or more VDCs comprising the virtual objects and one or more virtual data stores, such as virtual data stores 638 and 640. For example, one VDC may comprise VMs 628 and virtual data store 638. Automated methods and systems described herein are executed by a log management server 642 implemented in one or more VMs on the administration computer system 608. The log management server 642 receives log messages generated by event sources and records the log messages in log files as described below.

FIGS. 6B-6C show the example log management server 642 receiving log messages from event sources. Directional arrows represent log messages sent to the log management server 642. In FIG. 6B, operating systems and applications running on PC 610, server computers 608 and 644, network devices, and mass-storage array 646 send log messages to the log management server 642. Operating systems and applications running on clusters of server computers may also send log messages to the log management server 642. For example, a cluster of server computers 612-615 sends log messages to the log management server 642. In FIG. 6C, guest operating systems, VMs, containers, applications, and virtual storage may independently send log messages to the log management server 642.

### Processes and Systems for Performing Curation of Log Messages Generated by Event Sources of an Application

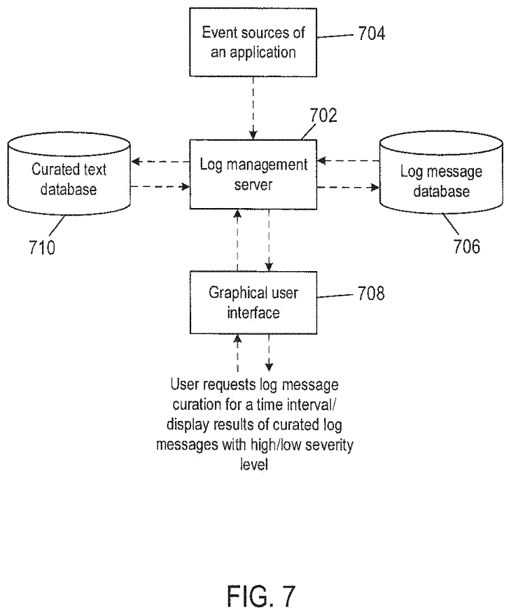

FIG. 7 shows an overview of an automated computer-implemented processes performed by a log management server for curating log messages and discovery of problems recorded in curated texts of the log messages. In FIG. 7, a log management server 702 receives log messages generated by event sources of an application 704 running in a distributed computing system as describe above. The log management server 702 is run on a host in one or more VMs as described above with reference to FIGS. 6A-6C. The application may be a stand-alone application running in a VM or running directly on a host. The application may be a distributed application with software components running in VMs or containers of one or more hosts. The log management server 702 tags the log messages based on log message classifications and stores the log messages and associated classification tags in a log file that is persisted in a log message database 706. Methods and systems for classifying and tagging log messages by classification are described in U.S. application Ser. No. 17,100,766, filed Nov. 20, 2020, which is owned by VMware Inc. and is hereby incorporated by reference. The log management server 702 provides a graphical user interface (“GUI”) 708 that is displayed on a computer monitor or other display device. The GUI 708 enables a user, such as a system administrator, a software engineer. or an application owner, to input a request for curation of log messages recorded in a user-selected time interval. In response to receiving a request via the GUI 704, the log management server 702 queries the log message database 706 for log messages with time stamps in the user-selected time interval. The log message database 712 includes a log database management system (“DBMS”) and one or more data-storage devices. The log DBMS responds to the request by reading a representative log message from each class of log messages with time stamps in the user-selected time interval from the application log files stored on the data-storage device and forwards the log messages to the log management server 702. The log management server 702 performs log message curation, as described below, on the representative log messages to obtain corresponding curated text statements and stores the curated text statements in a curated text statements database 710. A curated text statement of a log message are character strings extracted from the log message by the log management server 702 that are understandable by a human reader. The curated text database 710 includes a curated text DBMS and one or more data-storage devices. The log management service 702 retrieves curated text statements that correspond to the time interval from the curated text database 708, identifies character strings in the curated text statements that indicate a problem with the application, and displays the curated text statements and associated levels of severity associated with the curated text statements in the GUI 708. The automated computer-implemented operations performed by the log management server 702 described in detail below significantly reduces the amount of time and costs of deciphering log messages to reveal the human readable content of the log messages and is accomplished with minimal human involvement, thereby reducing, or eliminating entirely, human errors in the discovery of problems with an application.

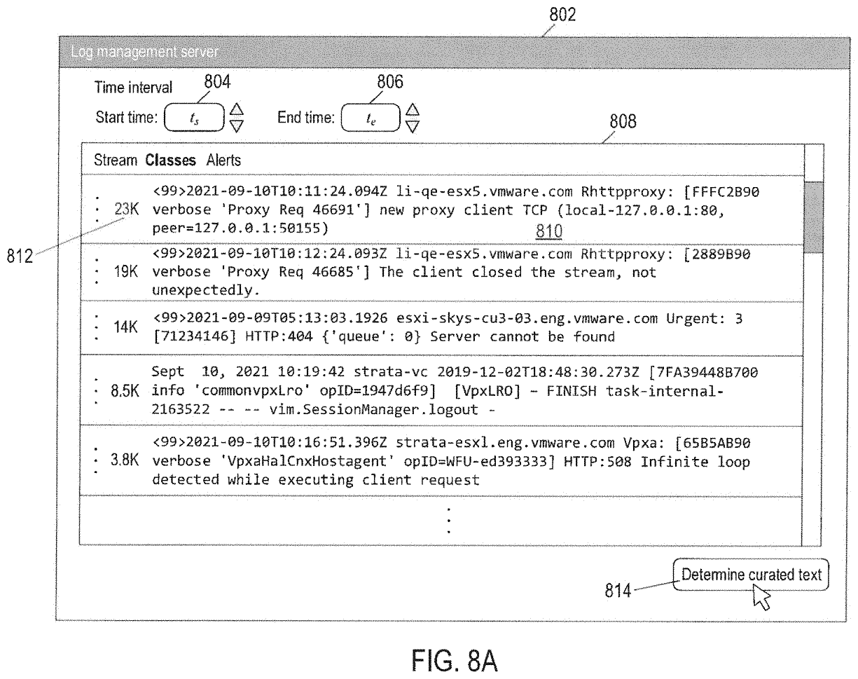

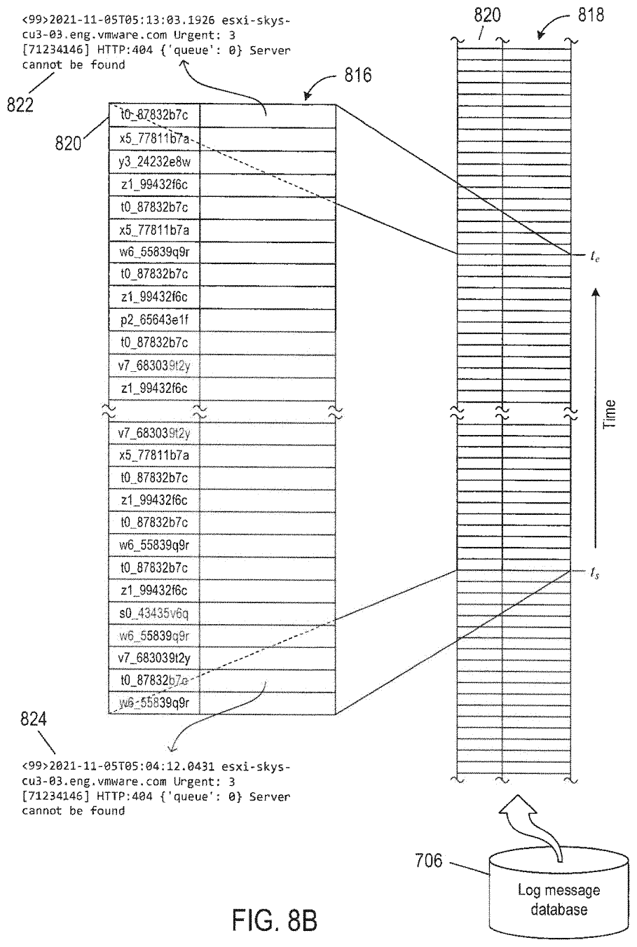

FIG. 8A shows an example GUI 802 that enables a user to select a time interval and displays log messages by class. The GUI 802 includes a field 804 that enables a user to input a start time, tₛ, of the time interval and includes a field 806 that enables a user to input an end time, tₑ, of the time interval. The GUI 802 also includes a window 808 thin displays examples of different classes of log messages. A representative log message of each class is displayed along with a count of the number of log messages in each class. For example, log message 810 is a representative log message of log messages belonging to a class comprising approximately twenty-three thousand 812 log messages in the time interval [tₛ, tₑ]. A user clicks on the “Determine curated text” button 814 and the process of determining curated texts from representative log messages of each class of log messages in the time interval is performed by the log management server 702. The log management server 702 retrieves representative log messages of each class of log messages with time stamps in the time interval [tₛ, tₑ] from the log message database 706. FIG. 8B shows an example of log messages 816 with time stamps in the time interval [tₛ, tₑ] retrieved from a log file 818 persisted in the log message database 706. The log file 818 stores log messages generated by event sources of the application. Log messages of the same class have been tagged with corresponding classification tags in column 820. For example. log messages 822 and 824 belong to the same class, have different time stamps, and have the same classification tag “t0_87832b7c.” The log management server selects a representative log message of each class of log messages for log message curation described below. For example, log messages 816 contain at least eight log messages with the same classification tag “t0_87832b7c.” The log management server 702 selects the most recently generated log message 822 in the time interval [tₛ, tₑ] as a representative log message of the class to determine a corresponding curated text for the class identified by the classification tag “t0_87832b7c.”

The log management server 702 uses Grok expressions that correspond to the log messages to extract character stings and parameters from the log messages. A Grok expression is a language parsing expression that is unique to the format of a class of log messages and is used by the log management server 702 to extract character strings (e.g., words, terms, and alphanumeric character strings) and parameters from log messages that match the format of the Grok expression. Grok expressions are formed from Grok patterns, which are in turn representations of regular expressions. A regular expression, also called a “regex,” is a sequence of symbols that defines a search pattern in text data. Regular expressions are specifically constructed to match strings of characters in log messages and can be become lengthy and extremely complex. For example, because log messages are unstructured, different types of regular expressions are configured to match various different character strings used to record a date and time in the time stamp portion of a log message. Grok patterns are predefined symbolic representations of regular expressions that significantly reduce the complexity of manually constructing regular expressions. Grok patterns are categorized as either primary Grok patterns or composite Grok patterns that are formed from primary Grok patterns. A Grok pattern is called and executed using Grok syntax notation denoted by % {Grok pattern}. When a representative log message does not have a corresponding Grok expression, the log management server 702 automatically generates a corresponding Grok expression for the representative log message. The log management server 702 performs automated methods for constructing Grok expressions for each of the log messages using a Grok engine described in U.S. patent application Ser. No. 17/008,755, filed Sep. 1, 2020, which is owned by VMware Inc. and is herein incorporated by reference.

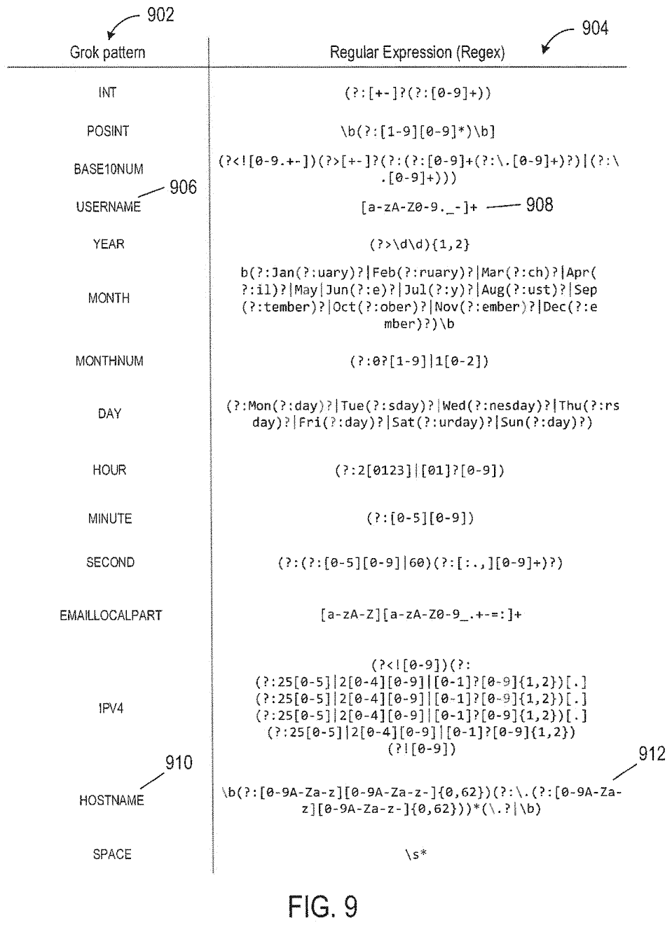

FIG. 9 shows a table of examples of primary Grok patterns and corresponding regular expressions. Column 902 contains a list of primary Grok patterns. Column 904 contains a list of regular expressions represented by the Grok patterns in column 902. For example, the Grok pattern “USERNAME” 906 represents the regex 908 that matches one or more occurrences of a lower-case letter, an upper-case letter, a number between 0 and 9, a period, an underscore, and a hyphen in a character string. Grok pattern “HOSTNAME” 910 represents the regex 912 that matches a hostname. A hostname comprises a sequence of labels that are concatenated with periods. Note that the list of primary Grok patterns shown in FIG. 9 is not an exhaustive list of primary Grok patterns.

A composite Grok pattern is formed from two or more primary Grok patterns. Composite Grok patterns may also be formed from combinations of composite Grok patterns and combinations of composite Grok patterns and primary Grok patterns.

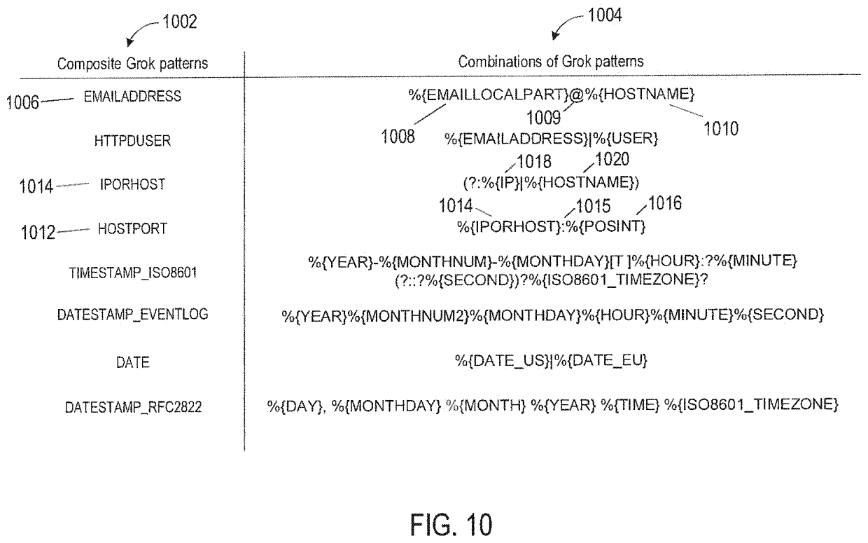

FIG. 10 shows a table of examples of composite Grok patterns. Column 1002 contains a list of composite Grok patterns. Column 1004 contains a list of composite Grok patterns that are represented by the Grok patterns in column 802. For example, composite Grok pattern “EMAILADDRESS” 1006 comprises a combination of “EMAILLOCALPART” 1008. an ampersand 1009, and “HOSTNAME” 1010. The Grok patterns “EMAILLOCALPART” 1008 and “HOSTNAME” 1010 are primary Grok patterns listed in the table shown in FIG. 9. The composite Grok pattern “EMAILADDRESS” 1006 matches the format of nearly any email address. Composite Grok pattern “HOSTPORT” 812 is a combination of a composite Grok pattern “IPORHOST” 1014, a colon 1015, and a primary Grok pattern “POSINT” 1016. The composite Grok pattern “IPORHOST” 1014 is a composite Grok pattern formed from primary Grok pattern “IP” 1018 and primary Grok pattern “HOSTNAME” 1020. Note that the list of composite Grok patterns shown in FIG. 10 is not an exhaustive list of composite Grok patterns.

Composite Grok patterns also include user defined Grok patterns, such as composite Grok patterns defined by a user. User defined Grok patterns may be formed from any combination of composite and/or primary Grok patterns. For example, a user may define a Grok pattern MYCUSTOMPATTERN as the combination of Grok patterns % {TIMESTAMP_ISO8601} and % {HOSTNAME}, where TIMESTAMP_ISO8601 is a composite Grok pattern listed in the table of FIG. 10 and HOSTNAME is a primary Grok pattern listed in the table of FIG. 9.

The log management server 702 uses Grok patterns to map specific character strings into dedicated variable identifiers. Grok syntax for using a Grok pattern to map a character string to a variable identifier is given by:

%{GROK_PATTERN:variable_name}
where
GROK_PATTERN represents a Grok pattern; and
variable_name is a variable identifier assigned to a character string in text data that matches the GROK_PATTERN.

A Grok expression is a parsing expression that is constructed from Grok patterns that match characters strings in text data and is used to parse character strings of a log message. Consider. for example, the following simple example segment of a log message:

34.5.243.1GET index.html14763 0.064

The five character strings of the segment are “34.5.243.1,” “GET,” “index.html,” “14763.” and “0.064.” A Grok expression that may be used to parse the example segment is given by:

\hat{ }%{IP:ip_address}\s%{WORD:word}\s%{URIPATHPARAM:request}\s%{INT:bytes}\s%{NUMBER:duration}$

The hat symbol “\hat{ }” identifies the beginning of a Grok expression. The dollar sign symbol “$” identifies the end of a Grok expression. The symbol “\s” matches spaces between character strings in the log message. The Grok expression parses the example segment by assigning the character strings of the log message to the variable identifiers of the Grok expression as follows:
ip_address:34.5.243.1
word:GET
request:index.html
bytes:14763
duration:0.064

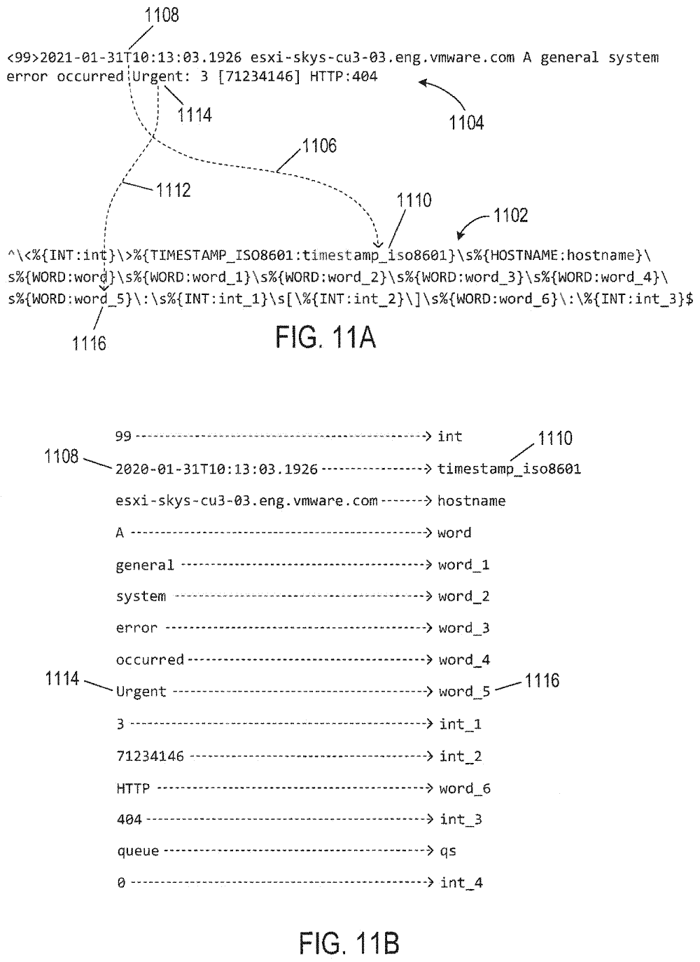

FIGS. 11A-11B show an example of parsing a log message with a Grok expression. FIG. 11A shows an example of a Grok expression 1102 constructed to parse a log message 1104. Dashed directional arrow 1106 represents assigning the character string 2019-07-31T10:13:03.1926 1108 in the log message 1104 to the variable identifier timestamp_iso8601 1110. Dashed directional arrow 1112 represents assigning the character string Urgent 1114 in the log message 1104 to the variable identifier word 1116. FIG. 11B shows assignments of the character strings of the log message 1104 to the variable identifiers of the Grok expression 1102.

The log management server 702 forms tokens from the character strings and associated Grok patterns denoted by “character_string|Grok_pattern.” For example, a token formed from the characters string “GET” and the corresponding Grok pattern “WORD” for the example segment above is “GET|WORD”. The log management server performs a filtering operation in which Grok patterns of the tokens are compared with Grok patterns in a list of disallowed Grok patterns persisted in a data-storage device. A token with a Grok pattern that matches a Grok pattern in the list of disallowed Grok patterns is denied and not used in construction of a set of curated text of a log message. By contrast, a token with a Grok pattern that does not match any of the Grok patterns in the list of disallowed Grok patterns is allowed to proceed to a next phase of filtering in construction of a set of curated text.

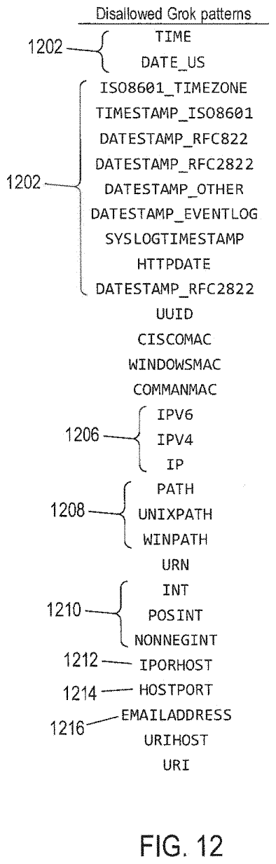

FIG. 12 shows an example list of disallowed Grok patterns. The list of disallowed Grok patterns contains Grok patterns for time and date 1202, time stamps 1204, IP addresses 1206, paths 1208, integer types 1210, host names 1212, port names 1214, and email addresses 1216, just to name a few. None of the character strings associated with the Grok patterns listed in FIG. 12 are used to construct a curated text.

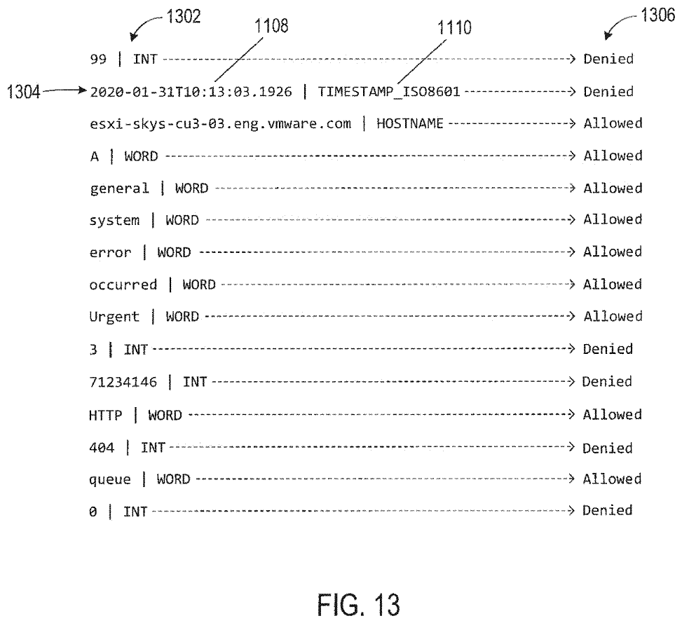

FIG. 13 shows an example of tokens formed from the character strings of the log message 1104 and Grok patterns of the Grok expression 1102 in FIG. 11. Column 1302 contains a list of tokens. For example, token 1304 contains the time stamp character string 1108 of the log message 1104 and corresponding Grok pattern 1306 of the Grok expression 1102. Tokens with Grok patterns that are in the list of disallowed Grok patterns in FIG. 12 are denied use in construction of a curated text for the log message 1104. Tokens with Grok patterns that are not in the list of disallowed Grok patterns in FIG. 12 are allowed and passed to a next filtering stage in the construction of a set of curated text for the log message 1104. Column 1306 contains a list of allowed or denied tokens based on the list of disallowed Grok patterns in FIG. 12.

After filtering based on disallowed Grok patterns, log management server 702 filters character strings of corresponding allowed Grok patterns by discarding character strings comprised of only special characters, such as brackets, parentheses, a coma, a period, an exclamation point, and any special symbols (e.g., @, #, $, %, &, and *). The log management server 702 determines the number of characters in non-discarded character strings and discards character strings that fail to satisfy the following condition:

maxstring_length>length(character_string)>minstring_length (1)
where
length(character_string) is the string length or number of characters in the character string character_string;
maxstring_length is the maximum string length (i.e., maximum number of characters); and
minstring_length is the minimum string length (i.e., minimum number of characters).
   For example, the maxstring_length may be set to 30 and the minstring_length may be set to 2.

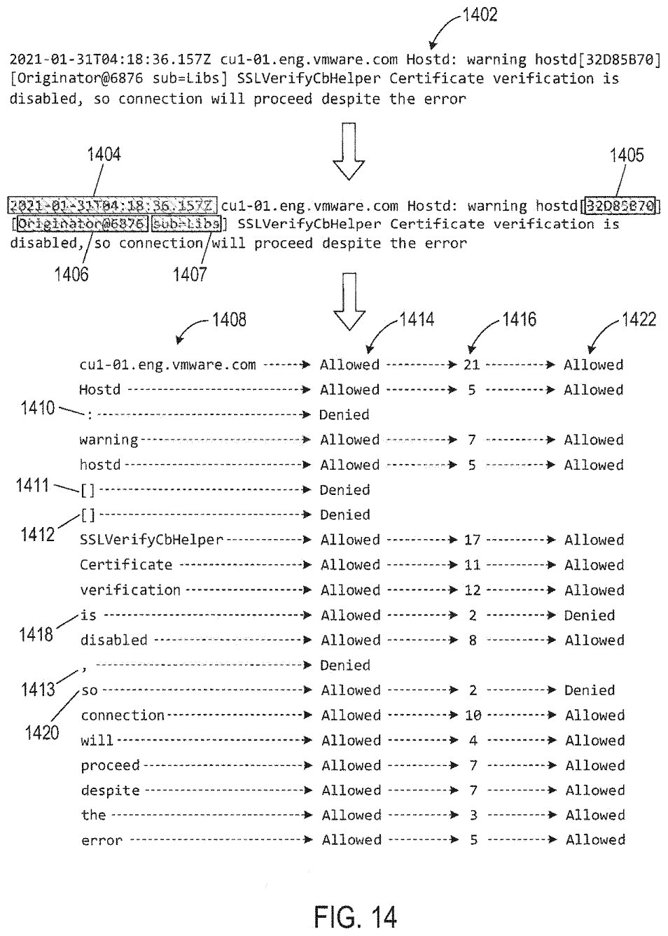

FIG. 14 shows an example of denying special characters and character strings that are outside permissible maximum and minimum character string lengths for an example log message 1402. The log management server 702 denies character strings of the log message 1402 that correspond to Grok patterns in the disallowed Grok pattern list shown in FIG. 12. Shaded boxes 1404-1407 represent character strings that have been denied because the corresponding Grok patterns are on the disallowed Grok pattern list shown in FIG. 12. Column 1408 is a list of character strings that do not have corresponding Grok patterns in the disallowed Grok pattern list. The log management server 702 filters the list of character strings by denying special characters 1410-1413 as indicated in column 1414. The log management server counts the number of characters in each string as displayed in column 1416. In this example, the maxstring_length is set to 30 and the minstring_length is set to 2. In column 1416, because the character string “is ” 1418 and the character string “so” 1420 are outside the permissible character string length of Equation (1), character strings 1418 and 1420 are denied. Column 1422 is a list of allowed and denied character strings based on string length.

The log management server 702 compares each character string that satisfies the condition in Equation (1) to allowed character strings persisted in an allowed character string database. The allowed character string database includes a DBMS that stores and retrieves allowed character strings from a data-storage device. The allowed character string database comprises user-selected character strings that appear in log messages and are allowed in curated texts. The allowed character strings selected by a user may be terms created by software engineers that describe specific types of data center objects or resources utilized by an application or named components of an application that aid a reading in understanding how the curated text obtained from a log message relate to the application.

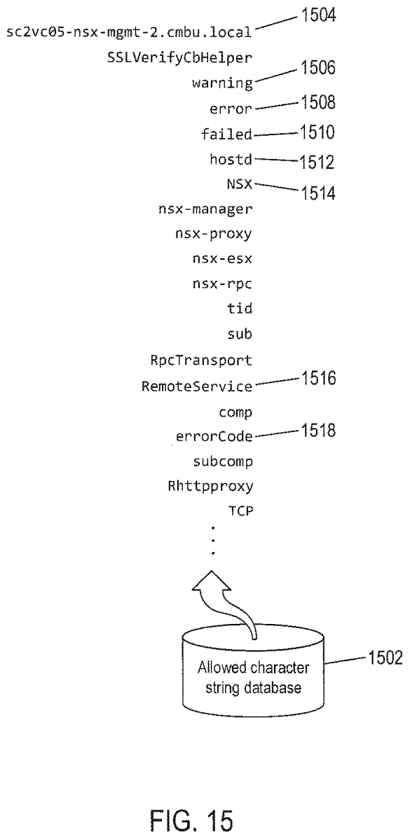

FIG. 15 shows an example list of allowed character strings stored in an allowed character string database 1502. In this example, the allowed character strings include user-created address names, such as address name 1504, words that identify problems, such as “warning” 1506. “error” 1508, “failed” 1510, abbreviated words, such as “hostd” 1512, and abbreviations, such as “NXS” 1514, and user-created compound words, such as “errorcode” 1520 and “subcomp” 1522.

When a character string matches an allowed character string in the allowed character string database. the log management server 702 adds the character string to a set of curated text. On the other hand, when a character string does not match an allowed character string, the log management server uses a natural language processor (“NLP”) engine to assign a probability to the character string denoted by Prob (character_string). The NLP engine is a trained neural network that receives a character string as input and outputs a probability that the character string is a word used in natural language. The log management server tags the character string with the probability output from the NLP engine. If the probability of the character string satisfies the following condition:

Prob(character_string)>Th_{prob} (2)

where Th_{prob} is a probability threshold, the log management server 702 adds the corresponding character string to a set of curated text. For example, the probability threshold may be set to 0.60 or 0.70.

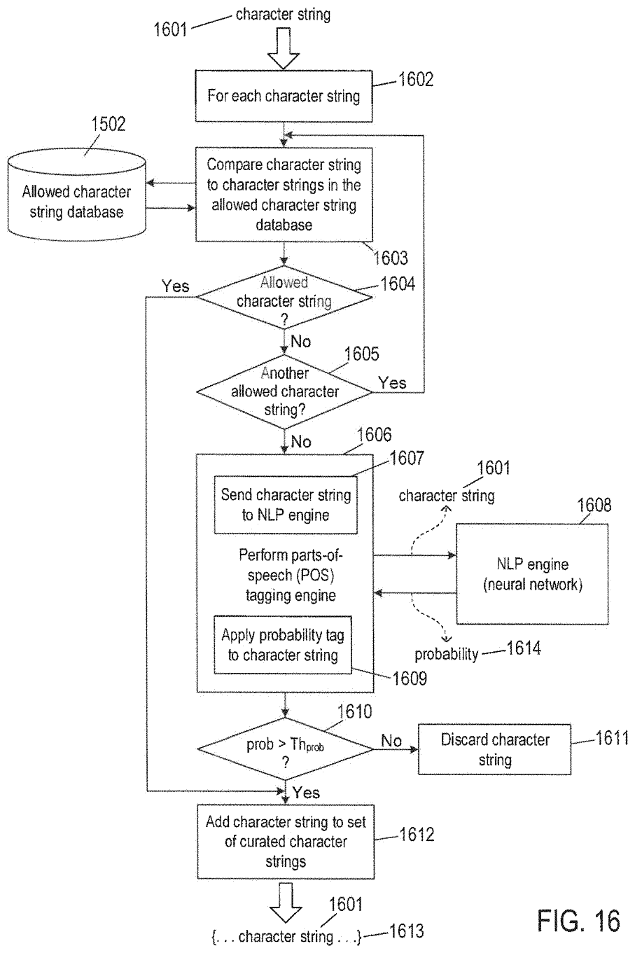

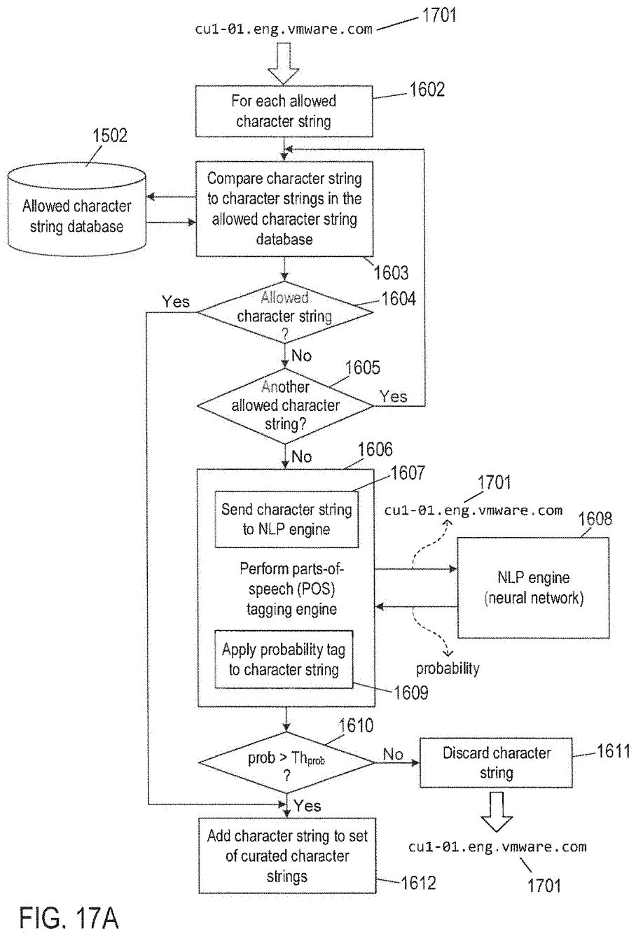

FIG. 16 is a flow diagram of a process executed by the log management server 702 for forming a set of curated text from character strings that satisfy the condition in Equation (1). In the example of FIG. 16, a character string 1601 satisfies the condition in Equation (1). A loop beginning with block 1602 repeats the computational operations represented by blocks 1603-1605 for each of the allowed character strings in the allowed character strings database 1502. In block 1603, the character string 1601 is compared with an allowed character string in the allowed character string database 1502. In decision block 1604 if the character string 1601 matches one of the allowed character strings, control flows to block 1612. In block 1612, the character string is added to a set of curated text 1613. In decision block 1605, when none of the allowed character strings matches the character string 1601, control flows to block 1606. In block 1606, a POS tagging engine receives the character string 1601. In block 1607, the POS tagging engine 1606 inputs the character string 1601 to an NLP engine 1608. The NLP engine 1608 outputs a probability, Prob(character_string), 1614 that the character string 1601 is a word used in natural language to the POS tagging engine 1606. In block 1609, the POS tagging engine 1607 tags the character string 1601 with the probability 1614. In decision block 1610, if the probability is greater than the probability threshold as described above with reference to Equation (2), control flows to block 1612 and the character string 1601 is added to the set of curated text 1613. Otherwise, control flows to block 1611 and the characters string 1601 is discarded.

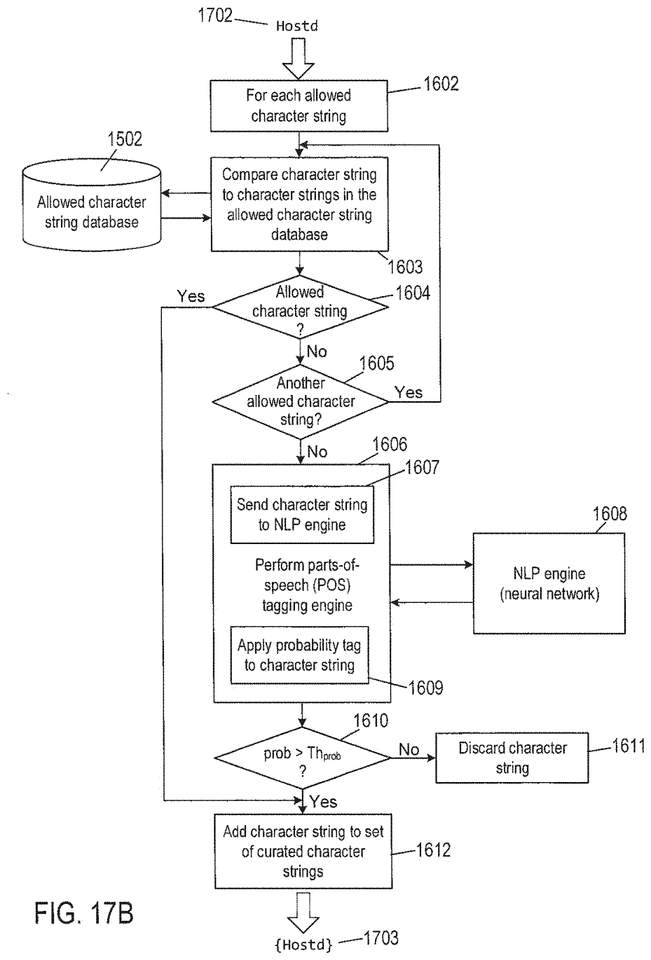

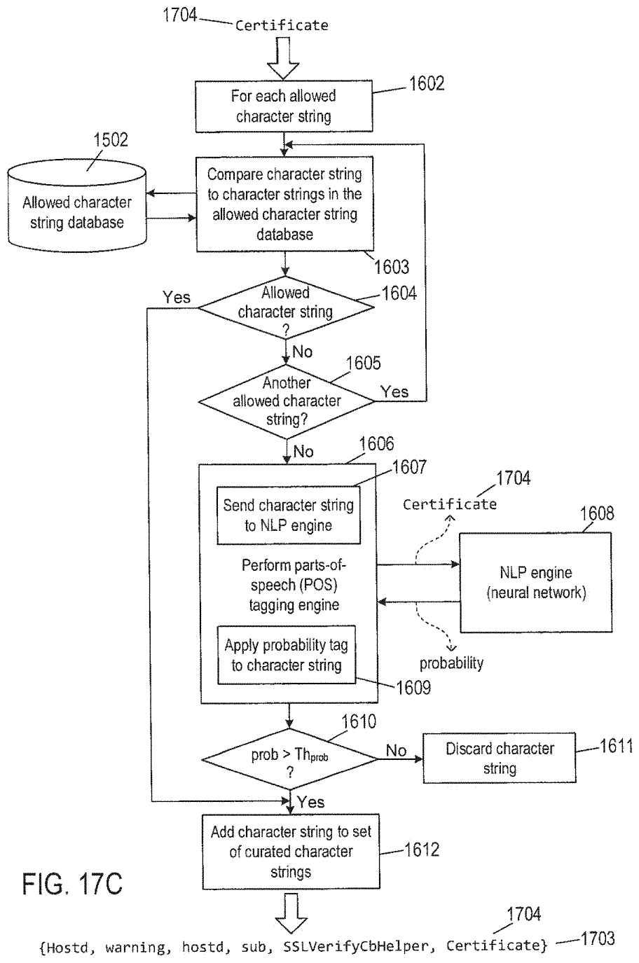

FIGS. 17A-17C show an example of the process for forming a set of curated text in FIG. 16 applied to three character strings of the log message 1402 in FIG. 14 that satisfy the condition in Equation (1). In FIG. 17A, the character string “cu1-01.eng.vmware.com” 1701 does not match any of the allowed character strings in the allowed character string database 1502 of FIG. 15. The POS tagging engine 1606 inputs the character string “cu1-01.eng.vmware.com” 1701 to the NLP engine 1608. The NLP engine 1608 outputs a probability of the character string “cu1-01.eng.vmware.com” 1701 being a natural language word, which is less than the probability threshold. As a result, the character string “cu1-01.eng.vmware.com” 1701 is discarded in block 1611. In FIG. 17B, the character string “Hostd” 1702 matches one of the allowed character strings in the allowed character string database 1502 of FIG. 15. Control flows directly to block 1612 where the character string “Hostd” 1702 is the first term added to a set of curated text 1703. In FIG. 17C, the character string “Certificate” 1704 does not match any of the allowed character strings in the allowed character string database 1502 of FIG. 15. The POS tagging engine 1606 inputs the character string “Certificate” 1704 to the NLP engine 1608. The NLP engine 1608 outputs a probability of the character string “Certificate” 1704 being a natural language word, which, in this ease, is greater than the probability threshold and control flows to block 1612 where the character string “Certificate” 1704 is added to the set of curated text 1703.

The log management server 702 discards duplicate character strings from the set of curated text output from the process described above with reference to FIGS. 16-17C followed by merging the character strings into a curated text statement with spaces between character strings. The resulting curated text statement comprises human-readable text that enables a reader to understand the underlying message contained in the corresponding class of log messages. The resulting curated text statement is stored in a curated text statement database.

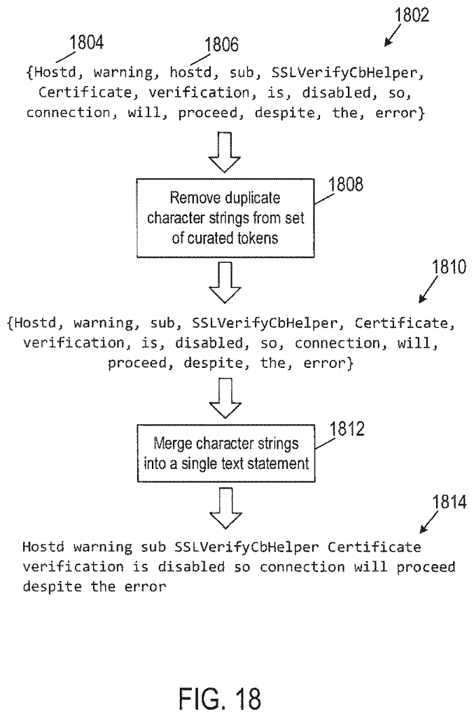

FIG. 18 shows an example of discarding duplicate character strings and merging character strings for the example set of curated text obtain for the log message 1402 in FIG. 14. Set of curated text 1802 contains duplication character strings “Hostd” 1804 and “hostd” 1806. In block 1808, the log management server 702 discards the second duplicate character string “hostd” 1806 to obtain a final set of curated text 1810. In block 1814, the log management server merges the character strings in the final set of curated text 1810 with spaces inserted between character strings to obtain a curated text statement 1814.

The log management server 702 compares each of the character strings in the curated text statement with problem character strings that signify a problem with the application. When a problem character string is detected, the log management server 702 tags the curated text statement with the problem character string. Examples of problem character strings that signify a problem application include “error,” “warning.” “critical,” “alert,” “alarm,” “unavailable,” “not found,” “failed,” and “failure.” The log management server uses the tags to identify curated text statements associated with problems in a GUI.

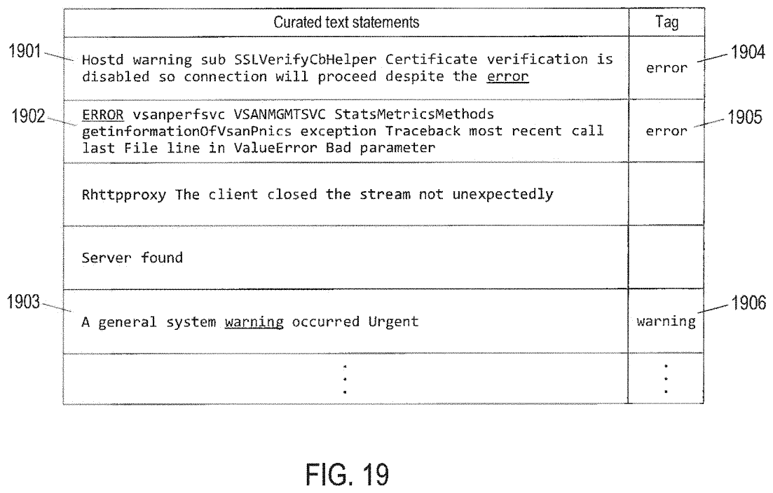

FIG. 19 shows examples of curated text statements and associated tags. Curated text statements 1901-1903 contain problem character strings “error” and “warning.” The log management server 702 tags the curated text statements 1901-1903 as indicated by tags 1904-1906. Curated text statements 1908 and 1909 are not tagged because these statements describe benign events and do not contain character strings that are indications of a problem.

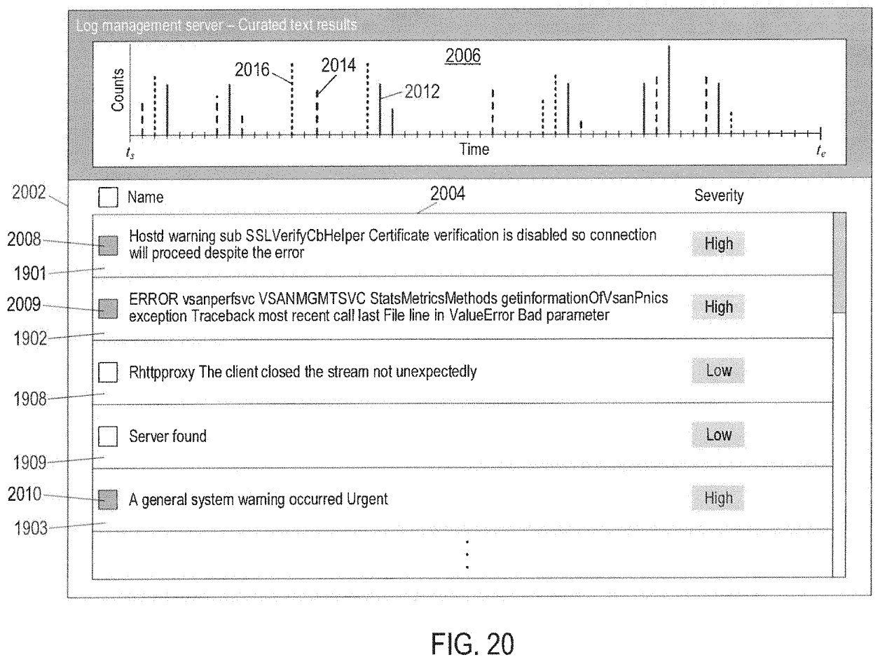

FIG. 20 shows an example GUI 2002 that displays the curated text statements in FIG. 19. The GUI 2002 includes a window 2004 that displays the curated text statements determined as described above for the user-selected time interval [tₛ, tₑ]. The window 2004 displays the curated text statements 1901-1903, 1908, and 1909. The tags 1904-1906 of the curated text statements 1901-1903 in FIG. 19 are used to identify the curated text statements 1901-1903 displayed in window 2004 as having a “high” severity level with respect to a problem with the application. A “high” severity level indicates that a problem is severe enough to warrant investigation. The benign curated text statements 1908 and 1909 in FIG. 19 are displayed in the window 2004 as having a “low” severity level. FIG. 20 includes a window 2006 that displays a count of log messages represented by selected curated text statements within the user-selected time window [tₛ, tₑ]. In this example. a user has clicked on boxes 2008-2010 and counts of the corresponding log messages generated by event sources of the application at different time stamps are plotted in the window 2006. Solid lines, such as solid line 2012, represent a count of the number of log messages represented by the curated text statement 1901. Long dashed lines, such as long dashed line 2014, represent a count of the number of log messages represented by the curated text statement 1902. Dashed lines, such as dashed line 2016, represent a count of the number of log messages represented by the curated text statement 1903.

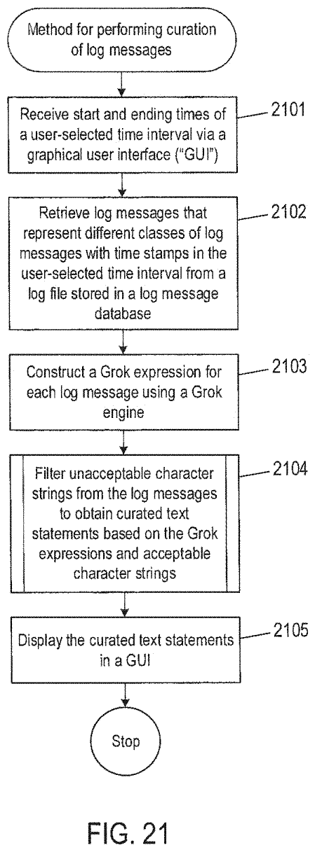

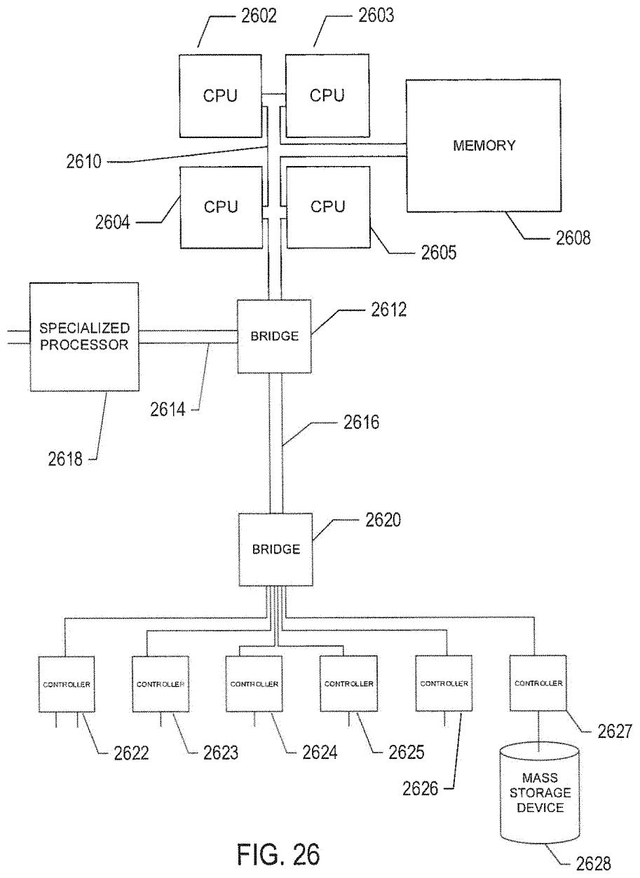

The methods described below with reference to FIGS. 21-25 are stored in one or more data-storage devices as machine-readable instructions and are executed by one or more processors of a computer system, such as the computer system shown in FIG. 26.

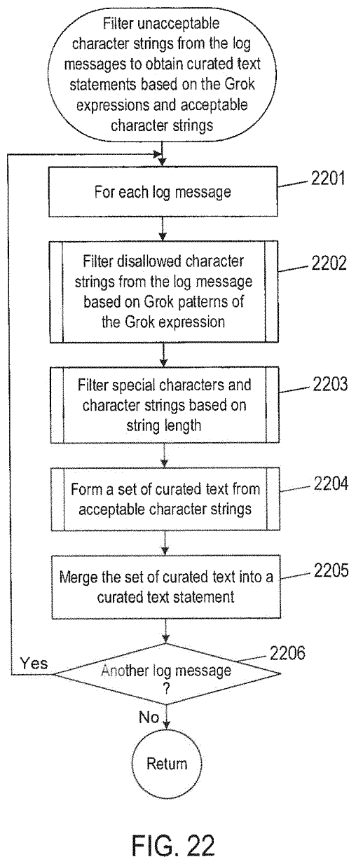

FIG. 21 is a flow diagram of a method for performing curation of log messages produced by event sources of an application. In block 2101, start and ending times of a user-selected time interval are received via GUI as described with reference to FIG. 8A. In block 2102, log messages that represent different classes of log messages with time stamps in the user-selected time interval from a log file stored in a log message database as described above with reference to FIG. 8B. In block 2103, Grok expressions are constructed for each of the log messages using a Grok engine described in U.S. patent application Ser. No. 17/008,755 described above with reference to FIGS. 8-10. In block 2104, a “filter unacceptable character strings from the log messages to obtain curated text statements based on the Grok expressions and acceptable character strings” procedure is performed. An example implementation of the “filter unacceptable character strings from the log messages to obtain curated text statements based on the Grok expressions and acceptable character strings” procedure is described below with reference to FIG. 22. In block 2105, the curated text statements output in block 2104 are displayed in a GUI as described above with reference to FIG. 20.

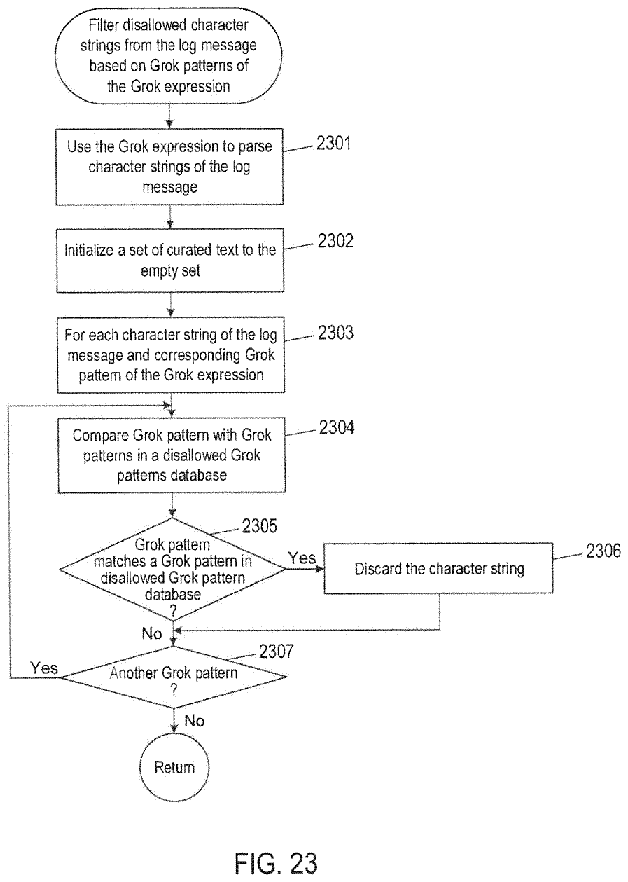

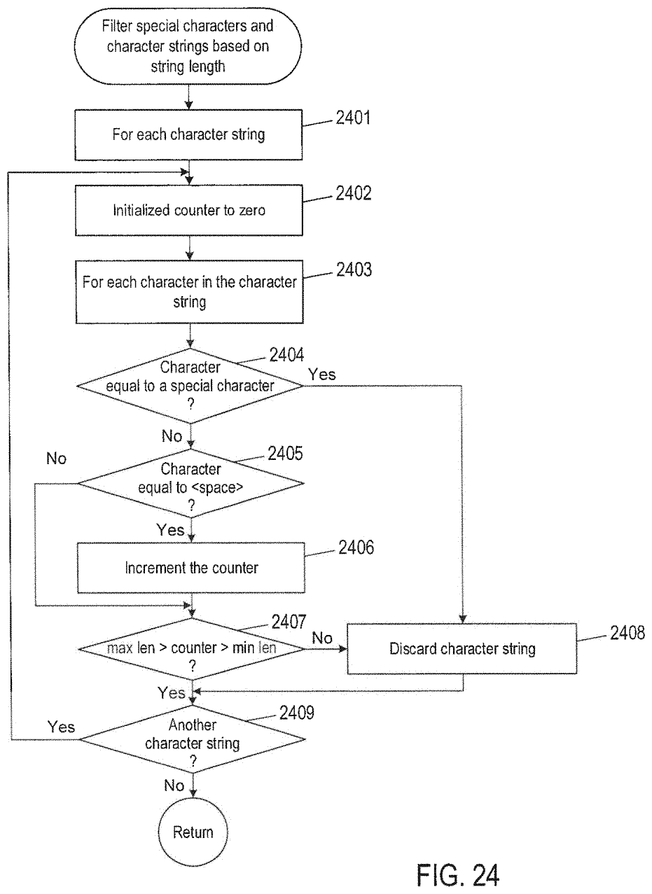

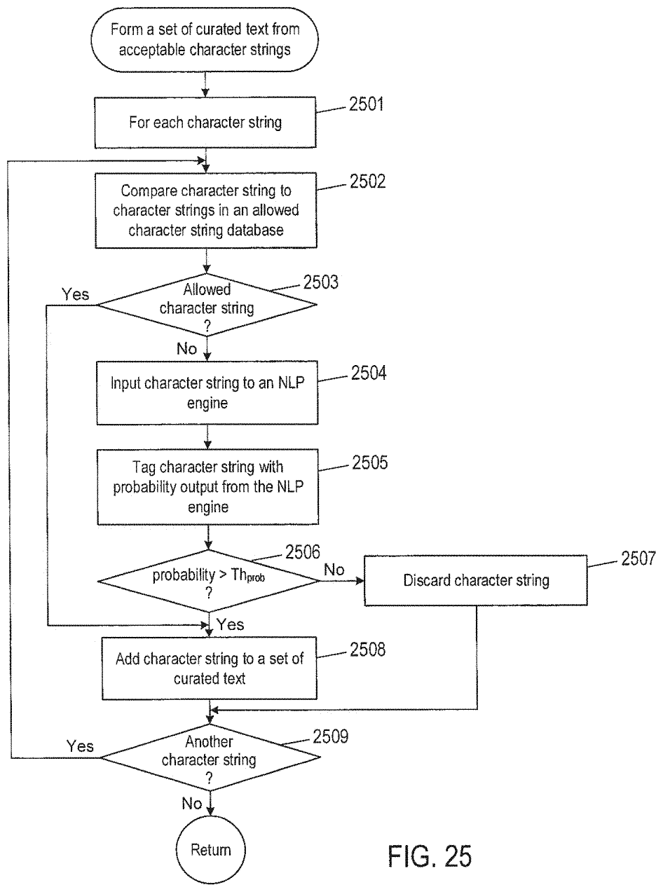

FIG. 22 is a flow diagram illustrating an example implementation of the “filter unacceptable character strings from the log messages to obtain curated text statements based on the Grok expressions and acceptable character strings” procedure performed in block 2104. A loop beginning with block 2201 repeats the computational operations represented by blocks 2202-2205 for each log message obtained in block 2102. In block 2202, a “filter disallowed character strings from the log message based on Grok patterns of the Grok expression” procedure is performed. An example implementation of the “filter disallowed character strings from the log message based on Grok patterns of the Grok expression” procedure is described below with reference to FIG. 23. In block 2203, a “filter special characters and character strings based on string length” procedure is performed. An example implementation of the “filter special characters and character strings based on string length” procedure is described below with reference to FIG. 24. In block 2204, a “form a set of curated text from acceptable character strings” procedure is performed. An example implementation of the “form a set of curated text from acceptable character strings” procedure is described below with reference to FIG. 25. In block 2205, the set of curated text is merged into a curated text statement. In block 2206, the operations represented by blocks 2202-2205 are repeated for another log message.

FIG. 23 is a flow diagram illustrating an example implementation of the “filter disallowed character strings from the log message based on Grok patterns of the Grok expression” procedure performed in block 2202. In block 2301, the Grok expression parses character strings of the log message as described above with reference to FIGS. 11A-11B. In block 2302, a set of curated text is initialized to the empty set. A loop beginning with block 2303 repeats the computational operations blocks 2304-2306 for each character string of the log message and corresponding Grok pattern of the Grok expression. In block 2304, compare the Grok pattern with Grok patterns of a disallowed Grok patterns database as described above with reference to FIG. 12. In decision block 2305, when the Grok pattern matches a Grok pattern in the disallowed Grok pattern database, control flows to block 2306. In block 2306, the character string is discarded. In decision block 2307, the operations represented by blocks 2304-2306 are repeated for another character string.

FIG. 24 is a flow diagram illustrating an example implementation of the “filter special characters and character strings based on string length” procedure performed in block 2203. A loop beginning with block 2401 repeats the computational operations represented by blocks 2402-2409 for each character string of the log message. In block 2402, a counter, denoted by counter, is initialized to zero. A final value for the counter is the length (i.e., number of characters) of the character string. A loop beginning with block 2403 repeats the computational operations represented by blocks 2404-2408 for each character in the character string. In decision block 2404, when a character in the character string matches a special character, control flows to block 2408. In decision block 2405, when the character does not match a space, control flows to block 2406 and the counter is incremented by one. On the other hand, when the character matches a space or empty character, the end of the character has been reached and control flows to decision block 2407. In decision block 2407, when the counter satisfies the condition in Equation (1), the character string is allowed. Otherwise, control flows to block 2408. In block 2408, the character string is discarded. In decision block 2409, the operations represented by blocks 2402-2408 are repeated for another character string.

FIG. 25 is a flow diagram illustrating an example implementation of the “form a set of curated text from acceptable character strings” procedure performed in block 2204. A loop beginning with block 2501 repeats the computational operations represented by blocks 2502-2508 for each character string. In block 2502, the character string is compared to character strings in an allowed character string database as described above with reference to FIG. 16. In decision block 2503, when the character string matches a character string in the allowed character string database, control floes to block 2508. Otherwise, control flows block 2504. In block 2504, the character string that does not match a character string in the allowed character string database, is input to an NLP engine. The NLP engine outputs a probability that the character string is a natural language word as described above with reference to FIGS. 17A-17C. In block 2505, the character string is tagged with the probability output from the NLP engine in block 2504. In decision block 2506, when the probability is greater than a probability threshold as described above with reference to FIG. 17C, control flows to block 2508. Otherwise, the probability is less than the probability threshold and control flows to block 2507. In block 2507, the character string is discarded. In block 2508, the character string is added to a set of curated text. In decision block 2509, the operations represented by blocks 2502-2508 are repeated for another character string.

FIG. 26 shows an example of a computer system that executes a log management server for curating log messages of an application and discovering problems in application as described above. The internal components of many small, mid-sized, and large computer systems as well as specialized processor-based storage systems can be described with respect to this generalized architecture, although each system may feature many additional components, subsystems, and similar, parallel systems with architectures similar to this generalized architecture. Computers that receive, process, and store log messages may be described by the general architectural diagram shown in FIG. 26, for example. The computer system contains one or multiple central processing units (“CPUs”) 2602-2605, one or more electronic memories 2608 interconnected with the CPUs by a CPU/memory-subsystem bus 2610 or multiple busses, a first bridge 2612 that interconnects the CPU/memory-subsystem bus 2610 with additional busses 2614 and 2616, or other types of high-speed interconnection media, including multiple. high-speed serial interconnects. These busses or serial interconnections, in turn, connect the CPUs and memory with specialized processors, such as a graphics processor, and with one or more additional bridges 2620, which are interconnected with high-speed serial links or with multiple controllers 2622-2627, such as controller 2627, that provide access to various different types of mass-storage devices 2628, electronic displays, input devices, and other such components, subcomponents, and computational devices. It should be noted that computer-readable data-storage devices include optical and electromagnetic disks, electronic memories, and other physical data-storage devices.

Those skilled in the art will recognize that any of many different implementation and design parameters, including choice of operating system, virtualization layer, programming language, modular organization, control structures, data structures, and other such design and implementation parameters can be varied to generate a variety of alternative implementations of automated computer-implemented processes and systems for performing log message curation and discovery of problems in an application. The automated process and systems described herein can be integrated into any of a variety of different automated-application-deployment facilities.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated computer-implemented process for curating log messages generated by event sources of an application, the process comprising:
displaying a graphical user interface (“GUI”) that enables a user to input a start time and an end time of a time interval and start the automated computer-implemented process for curating the log messages;
retrieving log messages that represent different classes of the log messages with time stamps in the time interval from a log file stored in a log message database;
using a Grok engine to construct a Grok expression for each log message that represents one of the classes;
filtering unacceptable character strings from the log messages that represent the one or more classes to obtain curated text statements based on the Grok expressions and acceptable character strings; and
displaying the curated text statements in a GUI, the curated text statements containing human-readable text that enables a reader to understand the underlying messages contained in the log messages.

2. The process of claim 1 wherein the filtering unacceptable character strings from the log messages to obtain curated text statements comprises:
for each log message,
filtering disallowed character strings from the log message based on Grok patterns of the Grok expression;
filtering character strings from the log message with special characters and character strings with string lengths that are greater than a maximum string length or less than a minimum string length:
forming a set of curated text from acceptable character strings; and
merging character strings of the set of curated text into a curated text statement;

3. The process of claim 2 wherein filtering disallowed character strings from the log message comprises:
parsing character strings of the log message using a corresponding Grok expression;
initializing a set of curated text to the empty set;
for each character string of the log message and corresponding Grok pattern of the Grok expression,
comparing the Grok pattern to Grok patterns of disallowed Grok patterns in a disallowed Grok patterns database; and
discarding the character string when the Grok pattern matches a Grok pattern in the disallowed Grok pattern database.

4. The process of claim 2 wherein filtering character strings from the log message with special characters and character strings with string lengths that are greater than a maximum string length or less than a minimum string length comprises:
for each character string of the log message,
initializing a counter to zero;
for each character in the character string,
discarding the character string when a character in the character string matches a special character;
incrementing the counter when the character does not match a space;
comparing the counter to the maximum string length and the minimum string length when the character does not match a space; and
discarding the character string when the counter is greater than the maximum string length or less than the minimum string length.

5. The process of claim 2 wherein forming the set of curated text from acceptable character strings comprises:
for each character string of the log message,
comparing the character string to character strings in an allowed character string database;
adding the character string to a set of curate text associated with the log message when the character string matches a character string in the allowed character string database;
inputting the character string to a natural language processing (“NLP”) engine that outputs a probability that the character string is a natural language word when the character string does not match a character string in the allowed character string database;
tagging the character string with the probability output from the NLP engine; and
adding the character string to a set of curate text associated with the log message when the probability is greater than a probability threshold.

6. A computer system for curating log messages generated by event sources of an application, the system comprising:
one or more processors;
one or more data-storage devices; and
machine-readable instructions stored in the one or more data-storage devices that when executed using the one or more processors controls the system to perform operations comprising:
displaying a graphical user interface (“GUI”) that enables a user to input a start time and an end time of a time interval and start the automated computer-implemented process for curating the log messages;
retrieving log messages that represent different classes of the log messages with time stamps in the time interval from a log file stored in a log message database;
using a Grok engine to construct a Grok expression for each log message that represents one of the classes:
filtering unacceptable character strings from the log messages that represent the one or more classes to obtain curated text statements based on the Grok expressions and acceptable character strings; and
displaying the curated text statements in a GUI, the curated text statements containing human-readable text that enables a reader to understand the underlying messages contained in the log messages.

7. The computer system of claim 6 wherein the filtering unacceptable character strings from the log messages to obtain curated text statements comprises:
for each log message,
filtering disallowed character strings from the log message based on Grok patterns of the Grok expression;
filtering character strings from the log message with special characters and character strings with string lengths that are greater than a maximum string length or less than a minimum string length;
forming a set of curated text from acceptable character strings; and
merging character strings of the set of curated text into a curated text statement;

8. The computer system of claim 7 wherein filtering disallowed character strings from the log message comprises:
parsing character strings of the log message using a corresponding Grok expression;
initializing a set of curated text to the empty set;
for each character string of the log message and corresponding Grok pattern of the Grok expression,
comparing the Grok pattern to Grok patterns of disallowed Grok patterns in a disallowed Grok patterns database; and
discarding the character string when the Grok pattern matches a Grok pattern in the disallowed Grok pattern database.

9. The computer system of claim 7 wherein filtering character strings from the log message with special characters and character strings with string lengths that are greater than a maximum string length or less than a minimum string length comprises:
for each character string of the log message,
initializing a counter to zero;
for each character in the character string,
discarding the character string when a character in the character string matches a special character;
incrementing the counter when the character does not match a space;
comparing the counter to the maximum string length and the minimum string length when the character does not match a space; and
discarding the character string when the counter is greater than the maximum string length or less than the minimum string length.

10. The computer system of claim 7 wherein forming the set of curated text from acceptable character strings comprises:
for each character string of the log message,
comparing the character string to character strings in an allowed character string database;
adding the character string to a set of curate text associated with the log message when the character string matches a character string in the allowed character string database;
inputting the character string to a natural language processing (“NLP”) engine that outputs a probability that the character string is a natural language word when the character string does not match a character string in the allowed character string database;
tagging the character string with the probability output from the NLP engine; and
adding the character string to a set of curate text associated with the log message when the probability is greater than a probability threshold.

11. A computer-readable medium encoded with machine-readable instructions that when executed by one or more processors of a computer system cause the computer system to perform operations comprising:
displaying a graphical user interface (“GUI”) that enables a user to input a start time and an end time of a time interval and start the automated computer-implemented process for curating log messages generated by event sources of an application;
retrieving log messages that represent different classes of the log messages with time stamps in the time interval from a log file stored in a log message database;
using a Grok engine to construct a Grok expression for each log message that represents one of the classes;
filtering unacceptable character strings from the log messages that represent the one or more classes to obtain curated text statements based on the Grok expressions and acceptable character strings; and
displaying the curated text statements in a GUI, the curated text statements containing human-readable text that enables a reader to understand the underlying messages contained in the log messages.

12. The medium of claim 11 wherein the filtering unacceptable character strings from the log messages to obtain curated text statements comprises:
for each log message,
filtering disallowed character strings from the log message based on Grok patterns of the Grok expression;
filtering character strings from the log message with special characters and character strings with string lengths that are greater than a maximum string length or less than a minimum string length;
forming a set of curated text from acceptable character strings; and
merging character strings of the set of curated text into a curated text statement;

13. The medium of claim 12 wherein filtering disallowed character strings from the log message comprises:
parsing character strings of the log message using a corresponding Grok expression;
initializing a set of curated text to the empty set;
for each character string of the log message and corresponding Grok pattern of the Grok expression,
comparing the Grok pattern to Grok patterns of disallowed Grok patterns in a disallowed Grok patterns database: and
discarding the character string when the Grok pattern matches a Grok pattern in the disallowed Grok pattern database.

14. The medium of claim 12 wherein filtering character strings from the log message with special characters and character strings with string lengths that are greater than a maximum string length or less than a minimum string length comprises:
for each character string of the log message,
initializing a counter to zero;
for each character in the character string,
discarding the character string when a character in the character string matches a special character;
incrementing the counter when the character does not match a space;
comparing the counter to the maximum string length and the minimum string length when the character does not match a space; and
discarding the character string when the counter is greater than the maximum string length or less than the minimum string length.

15. The medium of claim 12 wherein forming the set of curated text from acceptable character strings comprises:
for each character string of the log message,
comparing the character string to character strings in an allowed character string database;
adding the character string to a set of curate text associated with the log message when the character string matches a character string in the allowed character string database;
inputting the character string to a natural language processing (“NLP”) engine that outputs a probability that the character string is a natural language word when the character string does not match a character string in the allowed character string database;
tagging the character string with the probability output from the NLP engine; and
adding the character string to a set of curate text associated with the log message when the probability is greater than a probability threshold.
